(19) United States
(12) Patent Application Publication
(10) Pub. No.: US 2014/0095397 A1
(43) Pub. Date: Apr. 3, 2014

(54) CREATING VIRTUAL GROUPS FOR MANAGING A CONTACT CENTER

(71) Applicant: AVAYA INC., Basking Ridge, NJ (US)

(72) Inventors: Jonathan Robert Phillips, Plano, TX (US); Gregory D. Weber, Westminster, CO (US)

(73) Assignee: Avaya Inc., Basking Ridge, NJ (US)

(21) Appl. No.: 13/630,290

(22) Filed: Sep. 28, 2012

(51) Int. Cl. G06Q 10/00

(52) U.S. Cl. 705/304

(57) ABSTRACT

A first virtual group is dynamically created. A virtual group allows a supervisor or subject matter expert to virtually monitor contact center communications that an agent is currently associated with. The supervisor or subject matter expert can define criteria for a first event to create the virtual group. The first virtual group typically comprises a first agent avatar representing a first agent, a first monitoring avatar representing the supervisor or subject matter expert, and a first entity avatar representing a first customer. These avatars are created in a first virtual reality setting such as a virtual room. Using the first monitoring avatar, the supervisor or subject matter expert can virtually monitor a communication between the agent and the customer.

### TECHNICAL FIELD

Systems and methods that relate to contact centers and in particular virtualization of contact centers.

### BACKGROUND

Traditionally, agents and supervisors that provide support services for a product were all located in the same physical location. Because everyone was located at the same location, a supervisor could walk around the contact center and listen in on an ongoing call into the contact center. This allowed the supervisor to easily get a feel if there were any escalating issues arising in the contact center. However, even this was limited in the fact that the supervisor could only pick to listen to a single communication in the contact center.

Today, many of these contact centers are now geographically dispersed. In many cases, each of the dispersed contact centers may have a co-located supervisor that can listen in on conversations/communications between agents and customers. In addition, many contact centers allow an agent to work remotely at home. Under this new paradigm, a supervisor can no longer walk around the contact center because the supervisor and the agents may not even be in the same location. To compensate for this change, contact centers have attempted to provide tools that allow the supervisor to select an agent and listen in on a call. The problem is that these tools are limited and sometimes difficult to use. What is needed is a way to provide the same ability that the supervisor had previously in the geographically dispersed contact centers of today.

### SUMMARY

Systems, methods, and computer readable instructions are provided to solve these and other problems and disadvantages of the prior art. In an embodiment, a first virtual group is dynamically created. A virtual group is allows a supervisor or subject matter expert to virtually monitor contact center communications that an agent is currently associated with. The supervisor or subject matter expert can define criteria for a first event to create the virtual group. The first virtual group typically comprises a first agent avatar representing a first agent, a first monitoring avatar representing the supervisor or subject matter expert, and a first entity avatar representing a first customer. A customer can comprise the traditional customers in a contact center. In addition, a customer can include non-traditional customers such as a support organization, expert agents, and the like. These avatars are created in a first virtual reality setting such as a virtual room. Using the first monitoring avatar, the supervisor or subject matter expert can virtually monitor a communication between the agent and the customer.

In an embodiment, the first virtual group is dynamically modified based on a second communication that meets the criteria. The second communication is between a second agent and a second entity. The first virtual group is dynamically modified by creating a second agent avatar and a second entity avatar in the first virtual reality setting of the first virtual group. The second communication can be presented to the person that represents the first monitoring avatar based on a movement or position of the monitoring avatar in relation to where an agent avatar is located.

In an embodiment, the person representing the first monitoring avatar is the supervisor or subject matter expert. A second virtual group is dynamically created. The second virtual group includes a second agent avatar and a second entity avatar in a second entity setting. A second entity represented by the second entity avatar and a second agent represented by the second agent avatar are in a second communication. The virtual reality setting in the first virtual group is a virtual room and the second virtual reality setting is a second virtual room and the first virtual room and the second virtual room are connected, and wherein the first monitoring avatar can virtually go between the first virtual room and the second virtual room.

In an embodiment, the person that the first monitoring avatar represents is a supervisor or subject matter expert. The first event is identified by the supervisor or subject matter expert.

In an embodiment, the person that the first monitoring avatar represents is the supervisor. Based on the first event, the first virtual group represents a plurality of communications between a plurality of agents and a plurality of entities and each of the respective plurality of agents and plurality of entities has a respective avatar.

In an embodiment, the first communication comprises a plurality of communications between the first agent and a plurality of entities. The plurality of entities includes the first entity. The first virtual group includes a plurality of entity avatars that represent each of the plurality of entities. The person representing the monitoring avatar can monitor the plurality of communications.

In an embodiment, the first entity avatar is visually represented based on a medium of the first communication and the first agent avatar and the first monitoring avatar are visually represented using an avatar of a person. The first agent avatar and the first monitoring avatar are distinguished by at least one of a color, a size, a position, a location, an icon above an avatar (e.g., a star to indicate that a customer is important), and the first monitoring avatar being shown behind the first agent avatar.

In an embodiment, the first virtual group is dynamically modified based on a change to the communication. The communication is at least one of an end to the communication, a transfer of the communication, placing the communication on hold, and conferencing the communication.

In an embodiment, the first event is based on at least one of following: a type of customer, a company, a monetary value of the customer, a call type, a key word spoken in the first communication, a key word written in the first communication, an emotion detected in the first communication, a medium type of the first communication, a detected gesture in the first communication, a facial recognition of a person in the first communication, a voice print, a facial expression detected in the first communication, a language spoken in the first communication, a language written in the first communication, a contact history of a person, a skill level of the first agent, a contact center queue, a subject of the first communication, a location of the first agent, a an indication by a supervisor or subject matter expert, and a grouping of agents.

In an embodiment, the monitoring avatar is presented in a view that is shown only to the supervisor and the monitoring avatar is not displayed in a view that is presented to the agent. This can be presented based on an attribute defined by a supervisor.

In an embodiment, the event is based on a product or skill set of a group of agents. A corresponding entity avatar is created for each communication. The agent avatar is still created in the virtual group without a corresponding entity avatar and the agent avatar without a corresponding entity avatar can monitor communications of the agents that are involved in communications if an agent is not currently involved in a communication.

### BRIEF DESCRIPTION OF THE DRAWINGS

FIG. 1 is a block diagram of a first illustrative system for dynamically creating a virtualized group in a contact center.

FIG. 2 is a flow diagram of a method for dynamically creating a virtualized group in a contact center.

FIG. 3 is an enhanced flow diagram of a method for dynamically creating a virtualized group in a contact center.

FIG. 4 is an illustrative diagram of a virtual group for a communication.

FIG. 5 is an illustrative diagram of a virtual group for multiple communications.

FIG. 6 is an illustrative diagram of a virtual group for multiple communications.

FIG. 7 is an illustrative diagram of combining multiple virtual groups.

FIG. 8 is an illustrative diagram of a virtual group with multiple communications with a single agent.

### DETAILED DESCRIPTION

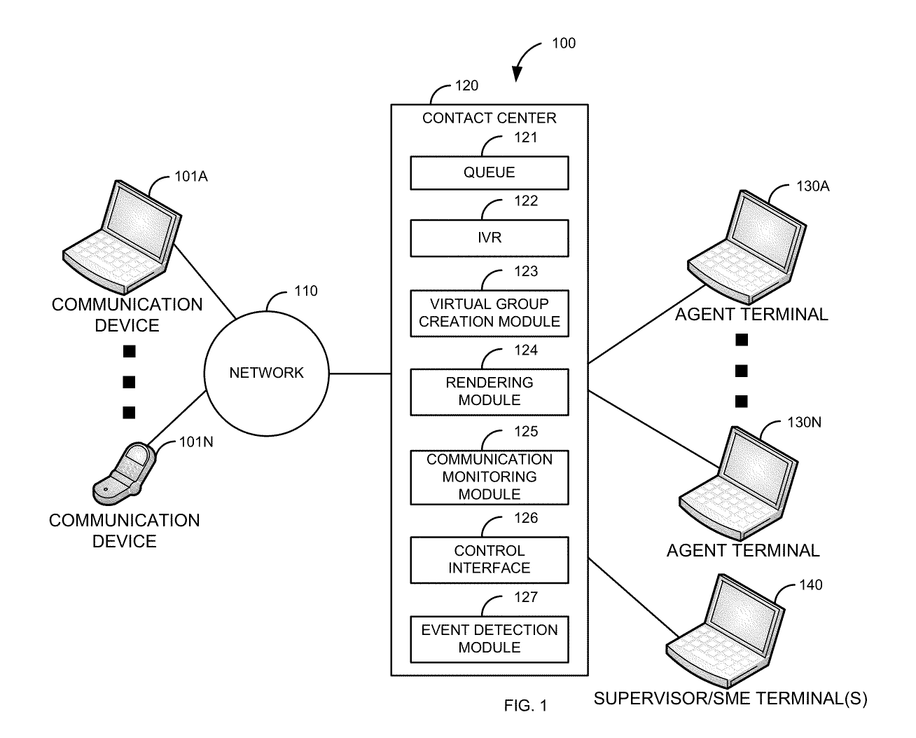

FIG. 1 is a block diagram of a first illustrative system 100 for dynamically creating a virtualized group in a contact center 120. The first illustrative system 100 comprises communication devices 101A-101N, a network 110, a contact center 120, agent terminals 130A-130N, and a supervisor/Subject Matter Expert (SME) terminal 140.

The communication device 101 may be any device that can communicate on the network 110, such as a Personal Computer (PC), a telephone, a video system, a cellular telephone, a Personal Digital Assistant (PDA), a tablet device, a notebook device, and the like. As shown in FIG. 1, any number of communication devices 101A-101N may be connected to network 110, including only a single communication device 101. In addition, the communication device 101 may be directly connected to the contact center 120.

The network 110 can be any network that can send and receive information, such as the Internet, a Wide Area Network (WAN), a Local Area Network (LAN), the Public Switched Telephone Network (PSTN), a packet switched network, a circuit switched network, a cellular network, a combination of these, and the like. The network 110 can use a variety of protocols, such as Ethernet, Internet Protocol (IP), Session Initiation Protocol (SIP), Integrated Services Digital Network (ISDN), and the like.

The contact center 120 can be any hardware/software that can provide support for communications. The contact center 120 may comprise various types of equipment, such as a Private Branch Exchange (PBX), a telephone switch, an external application server, a router, and a video switch. The contact center 120 comprises a queue 121, an Interactive Voice Response (IVR) system 122, a virtual group creation module 123, a rendering module 124, a communication monitoring module 125, a control interface 126, and an event detection module 127. The contact center 120 can handle a variety of communications, such as voice communications, video communications, emails, instant messaging, web chats, text messaging, and the like.

The queue 121 can be any queue that can handle communications in a contact center. The queue 121 may also be referred as a workflow engine or workflow logic in some environments. For example, the queue 121 can be used to manage various types of media, such as, voice, video, instant messaging, web chats, and text messages for the contact center 120. The IVR system 122 can be any voice/video voice response system for handling incoming communications into the contact center 120.

The virtual group creation module 123 can be any hardware/software that can provide virtualization of the contact center 120. The rendering module 124 can be any hardware/software that can display information or communications in the contact center 120. For example, the rendering module 124 can be a video card, a digital signaling processor, an audio codec, a video codec, and the like.

The communication monitoring module 125 can be any hardware/software that can monitor a communication, such as a Private Branch Exchange (PBX), a video switch, an email system, an instant messaging system, a web crawler, a communication system, a proxy server, and the like. The control interface 126 can be any hardware/software that can be used to provide administrative services in the contact center 120. The event detection module 127 can be any hardware software that can detect event.

The agent terminal 130 may be any device that can communicate with the contact center 120, such as, a Personal Computer (PC), a telephone, a terminal, a monitor, a video system, a cellular telephone, a Personal Digital Assistant (PDA), a tablet device, a note-book device, and the like. As shown in FIG. 1, any number of agent terminal 130A-130N may be connected to the contact center 120, including only a single agent terminal 130. In addition, the agent terminal 130 may be connected via network 110 to the contact center 120. The supervisor/SME terminal 140 can be any device that can connect to the contact center 120, such as the agent terminal 130, a communication device 101, and the like.

An entity, such as customer at the communication device 101A establishes a communication, such as a voice communication, via the network 110, into the contact center 120. The contact center 120 receives the communication. The customer may be provided a menu, via the IVR system 122 that allows the customer to select a product. Based on the product selection, the customer may be placed in the queue 121. At a later point in time, the customer is then serviced by an agent at agent terminal 130A. The agent, at agent terminal 130A can then service the communication with the customer.

This process can now be enhanced using virtual groups to animate various principles used in the contact center 120. The animation process can be similar to the animation process used in products such as Avaya's AvayaLive Engage™.

A supervisor or Subject Matter Expert (SME) can create an event that causes a virtual group to be created. A virtual group may be created dynamically or may be predefined. The virtual group, if predefined, may be rendered and displayed to a user. An event may be based on any criteria, such as a characteristic or condition. The event can be identified by a supervisor, SME, administrator, and the like. For example, an event may be based on a type of customer, a company, a monetary value of the customer, a call type, a key word spoken in the a communication, a key word written in the a communication, an emotion detected in the a communication, a medium type of the a communication, a detected gesture in the a communication, a facial recognition of a person in the a communication, a voice print, a facial expression detected in the a communication, a language spoken in the a communication, a language written in the a communication, a contact history of a person, a skill level of an agent, a contact center queue, a subject of a communication, a location of an agent, a an indication by a supervisor or subject matter expert, a grouping of agents, and the like. In addition, how the virtual group is created and displayed can also be based on the above characteristics or conditions.

The virtual group can contain an avatar that represents an agent and a monitoring avatar that represents a person, such as the supervisor or SME. The agent avatar and the monitoring avatar are created in a virtual reality setting. The virtual reality setting can be a virtual room, a virtual location, a virtual area, and the like. In addition, an entity avatar can also be created in the virtual reality setting. The entity avatar can represent an entity, such as a customer, a company, a device, a system, a person, and the like that is involved in a communication in the contact center 120. A communication can be any type of communication, such as a voice communication, a video communication, a text communication, an Instant Message (IM) communication, a web chat, a FAX communication, and the like. The created avatars are displayed in the virtual reality setting.

The event is detected by the event detection module 127. Once the event is detected by the event detection module 127, the virtual group creation module 123 creates the virtual group. The rendering module 124 renders the virtual group for display. The virtual group can be displayed to the entity, the agent, and/or the person represented by the monitoring agent. The communication monitoring module 125 provides the communication between the entity and the agent (visually and/or audibly) at supervisor/SME terminal 140 to the person represented by the monitoring avatar.

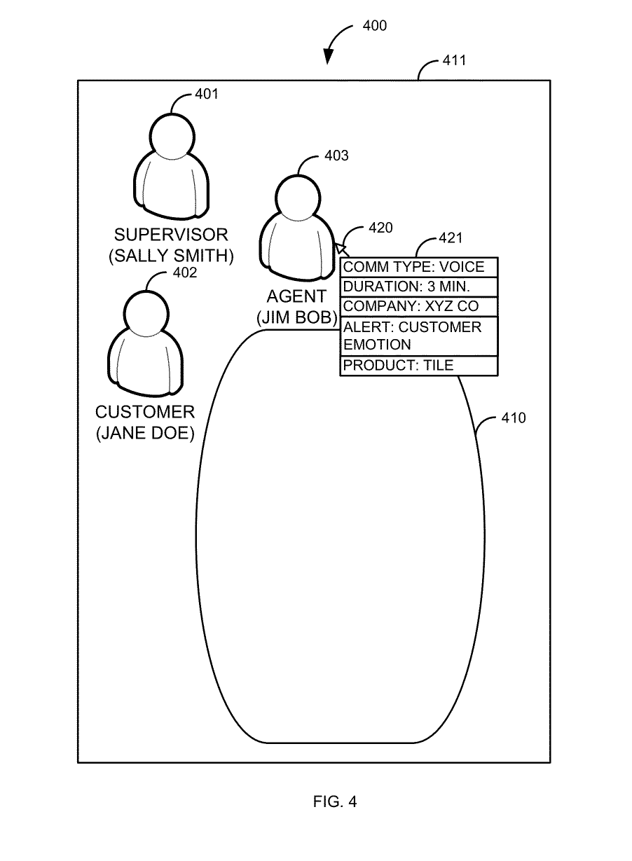

To better illustrate the creation of a virtual group, consider the following examples. A supervisor in the contact center 120 wants a virtual group created based on detection of an emotion, such anger, in a voice communication between an agent and a customer. After the customer has called the contact center 120 and a voice communication has been established with the agent (or even before as the customer uses IVR system 122), event detection module 127 detects the anger event (e.g., detecting the customer or agent yelling). Based on the anger event, a virtual group is created. The virtual group shows a virtual room that has an agent avatar and an entity avatar setting around a virtual table. The virtual group is presented to the supervisor. The monitoring avatar is shown standing behind the agent avatar and the entity avatar (e.g., like shown in FIG. 4). The supervisor is then provided with the audio communication between the agent and the customer. In another embodiment, if the supervisor is currently monitoring another communication, the virtual group may be created in a separate virtual room. This way, the supervisor can monitor the other communication and the new communication by switching between virtual groups.

The above examples describe a single communication between the entity and the agent being in the initial virtual group. However, if the criterion that defines the event covers multiple communications, the virtual group can be created for each of the communications. For example, if the criteria for the event is for all communications in German and there are ten active communications in German occurring the contact center 120, a virtual group will be created with ten agent avatars and ten entity avatars (assuming that each communication is between a different entity and a different agent). The supervisor or SME can then move the agent avatar so that the supervisor or SME can monitor each of the ten communications.

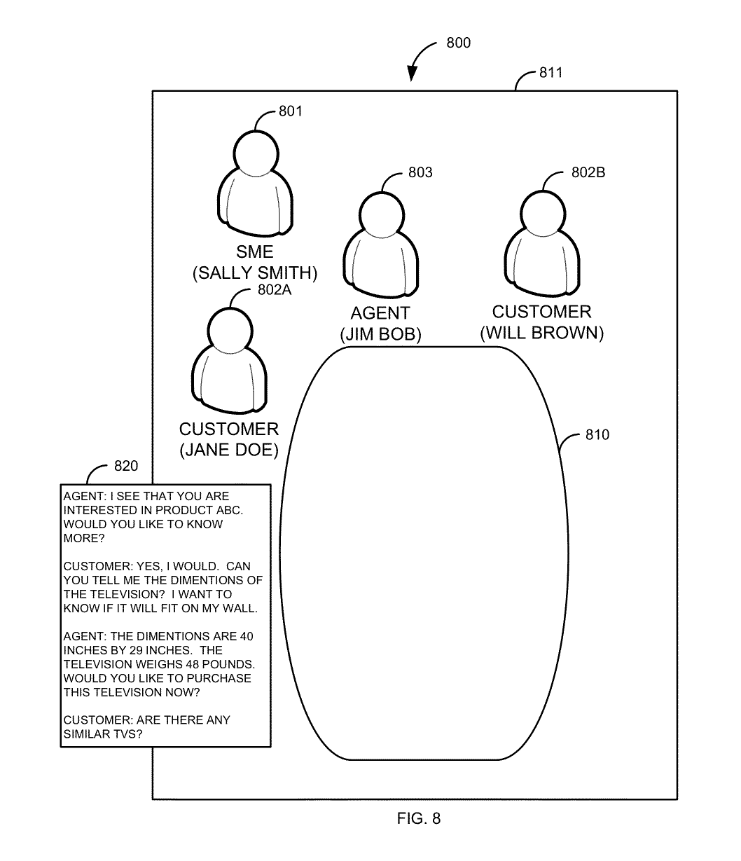

An agent can be working on multiple communications as that same time. For example, an agent can be in the process of handling multiple emails or web chats at the same time. The multiple communications can be on similar subjects or can be on different subjects. If an agent is currently supporting multiple communications that meet the criteria for the event, virtual group creation module 123 can create a virtual group that will show the agent and the two or more entities that are in communication with the agent (e.g., like shown in FIG. 8). The supervisor or SME can then move the monitoring agent avatar to view each of the communications. This could also be used in a voice or video situation where there are multiple customers in a conference or video call.

To further illustrate, consider the following example. A subject matter expert (SME) wants to view all active web chats that deals with product X. The SME defines the criteria using an administrative utility provided by the control interface 126. After defining the criteria, the SME clicks a button (the event) to create the virtual group in a virtual room. The virtual group includes all the current web chats with agents that deals with product X. For example, one agent may be currently supporting two web chats on product X (e.g., like shown in FIG. 8). Along with the agent avatar, there are two entity avatars (indicating that there are two communications between the agent and the customers), and the monitoring avatar The SME can then view each of the web chats by moving the monitoring avatar behind the entity avatar. If there were multiple agents in communication with multiple entities, a corresponding set of avatars will be created to represent the communications.

A virtual group can be dynamically modified by the virtual group creation module 123 based on the criteria defined for the event or based on what happens to the communication. The virtual group can be dynamically modified by virtual group creation module 123 based on a second communication that meets the criteria for the event. If the second communication is between a second agent and a second entity, the virtual group can be dynamically modified by adding an avatar for the second agent and an avatar for the second entity. This way the supervisor or SME can monitor the new communication. The supervisor or SME can monitor the new communication by moving the monitoring avatar to a position behind the agent avatar, by clicking a button, by selecting the agent avatar, by selecting the entity avatar and the like.

For example, if the event is to monitor all text and video communications in the contact center 120 that contain a specific key word, as communications that contain the key word are detected, an avatar for the entity and an avatar for the agent (if there is not already one in the virtual group) are added to the virtual group. This allows the supervisor or subject matter expert to dynamically monitor new communications in the contact center 120 by moving the monitoring avatar in a position behind the agent avatar and the entity avatar.

In addition, the virtual group may be dynamically changed based on the ending of a communication. For example, as a communication between the agent and the entity ends, the avatars for the agent and the entity are removed from the virtual group (assuming that the agent and/or the entity is not part of another communication that meets the criteria). In other embodiments, a communication can be monitored in other ways, such as, by clicking on an agent avatar, touching the screen, and the like.

Alternatively, the virtual group can be dynamically modified based on a change to the communication. For instance, if a communication is transferred from a first agent to a second agent, the virtual group creation module 123 can up the agent avatar to show the second agent that is now handling the call. If the agent conferences in a subject matter expert, an avatar for the subject matter expert can be added to the virtual group. If the communication is placed on hold, the color of the entity icon and the agent icon can change.

In addition to creating a first virtual group, virtual group creation module 123 can dynamically create multiple virtual groups. For example, a first virtual group may be created by an event for a first supervisor or SME and a second virtual group may be created based on an event for a second supervisor or SME. The events that create both virtual groups can each be based on different characteristics of the same communication. For instance, a first virtual group can be created based on communications involving product X and a second virtual group may be created based on all communications being in Spanish. If a communication is about product X and is in Spanish, the communication and respective avatars will be represented in both virtual groups (or in a new virtual group product X in Spanish may be created).

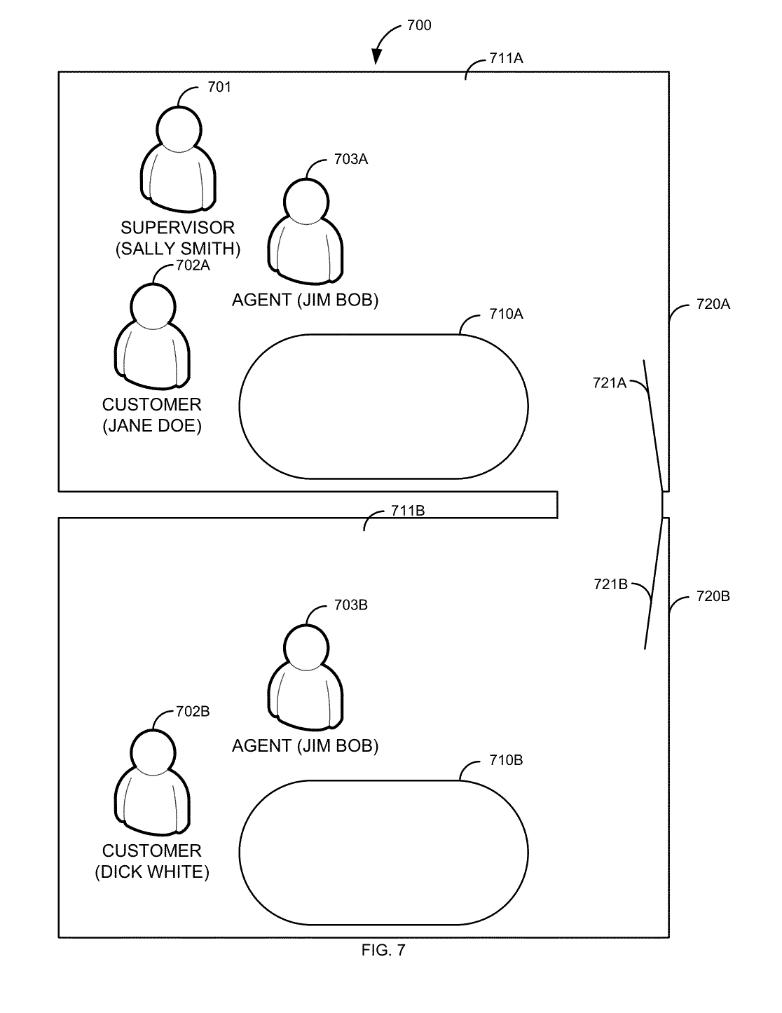

If the events have criteria that are defined by the same person or a group of persons, the virtual groups can be combined by virtual group creation module 123 so that an agent or supervisor can monitor both virtual groups at the same time (e.g., like shown in FIG. 7). For example a first virtual group can contain a first agent avatar and a first entity avatar that are engaged in a first communication and the monitoring avatar. The second virtual group can contain a second agent avatar and a second entity avatar that are engaged in a second communication. Each of the virtual groups can be represented as rooms with a corridor that connects the virtual groups. The monitoring avatar can then be moved between the rooms to monitor the first and second communications.

Alternatively, virtual groups may be created based exclusive criteria such as the first group being communications in English and the second virtual group based on communications based in French. For example, a bilingual supervisor may want to create two virtual groups to monitor communications in English and Spanish. The supervisor could monitor both virtual groups at the same time via supervisor/SME terminal 140. Alternatively, both of the Spanish and English virtual groups can be combined like shown in FIG. 7.

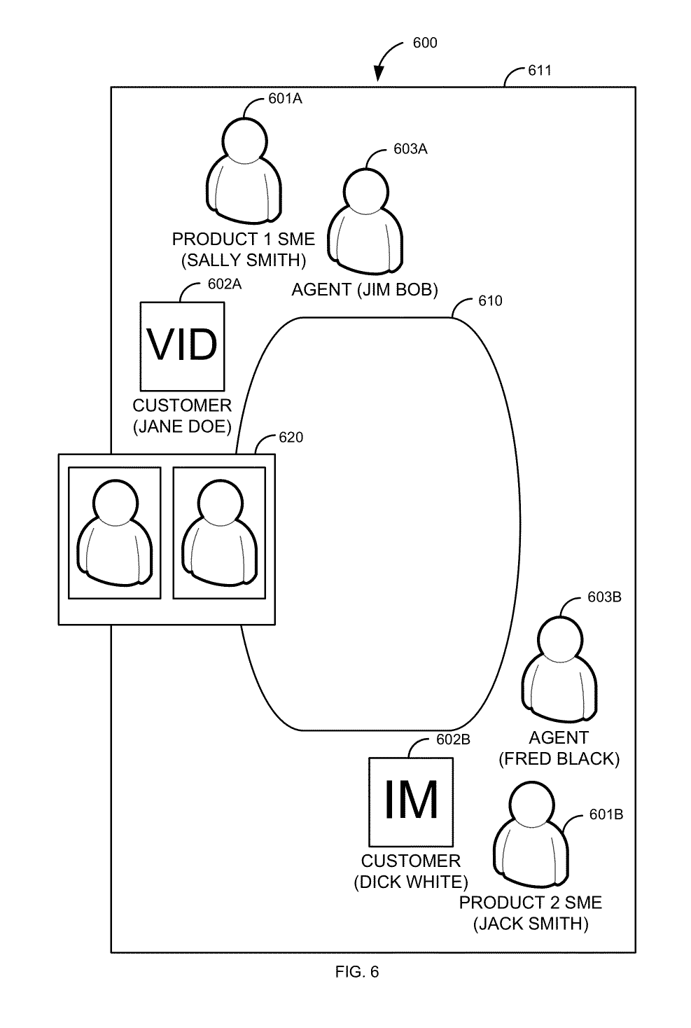

The avatars can be represented differently based on different criteria. For instance, the entity avatar can be visually represented based on a medium of a communication. The entity avatar can be show as a video camera to represent a video communication. The entity avatar can be shown as a telephone to represent voice communication, an envelope for an email communication, an IM for an Instant Messaging communication (e.g., like shown in FIG. 6), a VID for a video communication (e.g., like shown in FIG. 6), a T for a text communication, using a trademark symbol of a medium being used (e.g., using the Facebook™ trademark to indicate that the communication is a Facebook™ communication), and the like. The avatars can be distinguished using a color, a size, a position, a location, the first monitoring avatar being shown behind the first agent avatar, and the like. For example, the agent avatar could be red, the monitoring avatar could be blue, and the entity avatar could be green.

In addition, the view of the virtual group that is presented to an agent may be different than the view that is presented to a supervisor. Based on a defined attribute, the supervisor's view may show the entity avatar, the agent avatar, and the monitoring avatar. However, the agent's view may not show the monitoring avatar. This way the supervisor can monitor the communication without alerting the agent.

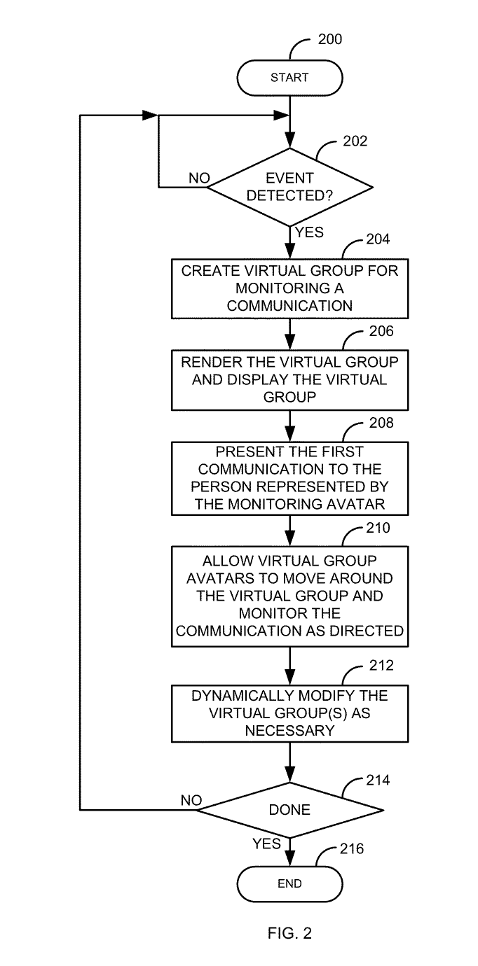

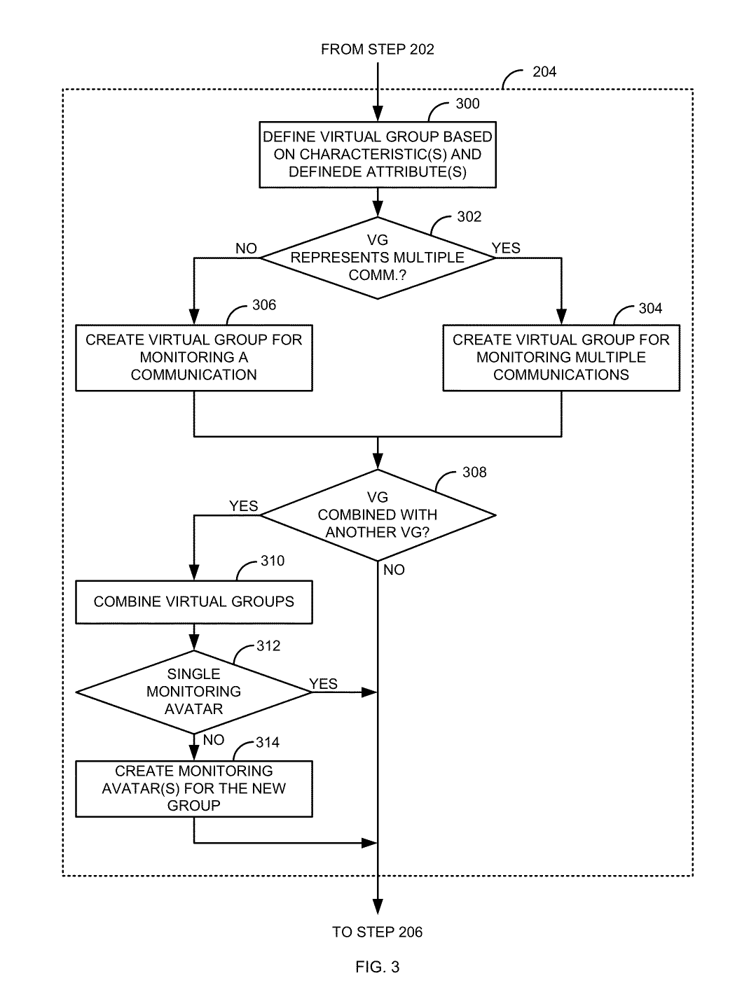

FIG. 2 is a flow diagram of a method for dynamically creating a virtualized group in a contact center 120. Illustratively, the module communication devices 101, the contact center 120, the queue 121, the IVR system 122, the virtual group creation module 123, the rendering module 124, the communication monitoring module 125, the control interface 126, the event detection module 127, the agent terminals 130, and the supervisor/SME terminal 140 are stored-program-controlled entities, such as a computer or processor, which performs the method of FIGS. 2-3 and the processes described herein by executing program instructions stored in a tangible computer readable storage medium, such as a memory or disk. Although the methods described in FIGS. 2-3 are shown in a specific order, one of skill in the art would recognize that the steps in FIGS. 2-3 may be implemented in different orders and/or be implemented in a multi-threaded environment. Moreover, various steps may be omitted or added based on implementation.

The process begins in step 200. The process waits in step 202 for an event to be detected. While waiting for an event to occur, the supervisor and/or the agents can see other agents waiting. If the supervisor perceives many waiting agents, she/he may elect to send some of them off to training or hold an impromptu virtual meeting. The lack of customer events does not remove the virtual representation of agents and supervisors/SMEs that are displayed. The event is based on various criteria, such as a communication or an occurrence in the communication. If the event is not detected in step 202, the process repeats step 202 waiting for an event. If an event is detected in step 202, the process creates 204 a virtual group for monitoring the communication. The virtual group can be created 204 based on the number of communications between an agent(s) and an entity(s) that meet the criteria defined for the event. In addition, other factors that can be defined by a supervisor or subject matter expert that define the event and how the virtual group is created. The virtual group will at least contain an agent avatar, a monitoring avatar, a virtual reality setting, and optionally an entity avatar. The virtual reality setting is typically a virtual room that contains the agent avatar, the monitoring avatar, and the entity avatar. The virtual group is rendered and displayed 206. The virtual group can be rendered and displayed 206 based on various criteria. For example, the virtual group can be displayed to both the supervisor and the agent. The communication is then presented 208 to the person represented by the monitoring avatar, which is typically a supervisor or subject matter expert.

The virtual group avatars can move 210 around the virtual group and monitor the communications as directed. Typically, only the monitoring avatars will be able to move around the virtual group. However, an agent avatar may also be allowed to move around the virtual group and monitor the communications of other agents. For example, if an agent has placed a communication on hold, the agent may be able to move the agent avatar to monitor another communication in the virtual group. In addition, agents may also be displayed in multiple rooms concurrently/simultaneously, since the agent may be handling multiple events or in collaboration sessions with different customer simultaneously.

In addition, the virtual group avatars can be moved around the virtual group based off key words. For example, if a customer says that they want to buy a kite, the key word “kite” may be used to move or place the avatar in a virtual group where the agent is an expert in kits. The customer may be placed in a different virtual group based on another key word. If the customer is in a virtual group, and later says that they are angry, another avatar of a supervisor/SME can be placed in the virtual group that is experienced dealing with angry people. Alternatively, based on criteria such as keywords (such as the customer saying they are angry), the customer, agent, or supervisor/SME may be copied into a second virtual group.

Alternatively, the virtual group may be created based on something other than a communication. For example, the virtual group may be crated to show all agents supporting product X. When the virtual group is created, the virtual group may show agents that are servicing communications and agents that are not servicing communications. An agent that is not servicing an entity may be allowed to monitor communications of other agents by the agent moving the agent avatar into a position to monitor the communications.

The virtual groups may be dynamically modified 212 as necessary. For example, the virtual groups can be dynamically modified as new communications that meet the criteria are met, as communications end, as new agents that meet the criteria come on shift, as agents take breaks, and the like. The processes described in step 210 and 212 can also be implemented using a separate thread. If the process is done in step 214, the process ends 216. Otherwise, the process goes to step 202 so that other events can be detected.

FIG. 3 is an enhanced flow diagram of a method for dynamically creating a virtualized group in a contact center. The process described in FIG. 3 is an expanded view of step 204 in FIG. 2. After the event is detected in step 202, the virtual group is defined 300 based on characteristics and defined attributes. For example, the virtual group may be defined by an attribute configured by a supervisor that the monitoring entity will not be shown to the agent. Alternatively, a virtual group may be created with multiple monitoring agents or a single monitoring agent. The virtual group can be defined based a communication or other criteria such as a group of agents in the contact center 120.

The process determines in step 302 if the virtual group represents multiple communications (e.g., multiple communications on different subjects). If the virtual group contains multiple communications, the virtual group is created 304 so that the multiple communications (and the corresponding avatars) are in the virtual group. Otherwise, if the virtual group contains a single communication (or no communications), the process creates 306 the virtual group for monitoring the communication.

A virtual group could be created based on no communications (e.g., the criteria for setting up the virtual group is all agents that supervisor manages). For example, if the event was to create a virtual group based on a group of agents monitoring product X and there are currently no communications by the group of agents working on product X, then the virtual group would only be created with the agent avatars and the monitoring avatar. As an agent takes a communication, the virtual group would be modified by creating an entity avatar next to the avatar of the agent in communication with the entity. In this scenario, the criteria to set up the virtual group may be for all agents with a specific skill set. The agents can be provided announcements by the supervisor using a whisper mode as information specific to that group of agents.

The process determines in step 308 if the virtual group is to be combined with another virtual group. If the virtual group is not to be combined with another virtual group in step 308, the process goes to step 206. Otherwise, the virtual groups are combined 310 (e.g., like shown in FIG. 7). If the combined virtual group requires multiple monitoring avatars in step 312, additional monitoring avatars are created 314 for the combined virtual group and the process goes to step 206. Adding additional avatars can also be created based on various criteria that can be defined by a supervisor or subject matter expert. Otherwise, if the combined group only requires a single monitoring avatar, the process goes to step 206.

FIG. 4 is an illustrative diagram of a virtual group 400 for a communication. The virtual group 400 comprises a monitoring avatar 401, an entity avatar 402, an agent avatar 403, a virtual table 410, a virtual reality setting 411, a cursor 420, and an information window 421. The virtual group 400 is an exemplary virtual group that can be created based on various criteria. The virtual group 400 shows supervisor Sally Smith (represented by the monitoring avatar 401) monitoring a communication between the customer Jane Doe (represented by the entity avatar 402) and the agent Jim Bob (represented by the agent avatar 403). The agent avatar 403 and the entity avatar 402 are shown positioned around the virtual table 410. The monitoring avatar 401 is shown behind the agent avatar 403 and the entity avatar 402.

In this example, the communication is a voice communication and the communication is presented audibly to supervisor Sally Smith at the supervisor/SME terminal 140. However, if the communication was a video communication or a text based communication, a portion or the entire screen on supervisor/SME terminal 140 can be dedicated to displaying the video communication or text based communication.

Sally Smith from supervisor/SME terminal 140 can click on the agent avatar 403 to bring up the information window 421. The information window 421 can be used to display various statistics on the supervisor/SME terminal 140. Using this method, each of the avatars can be clicked on to display information specific to the avatar or communication.

In addition, other types of information can be displayed to increase usability of the virtual group 400. For example, a line can be placed between the agent avatar 402 and the entity avatar 402 to indicate a communication between the agent Jim Bob and the customer Jane Doe.

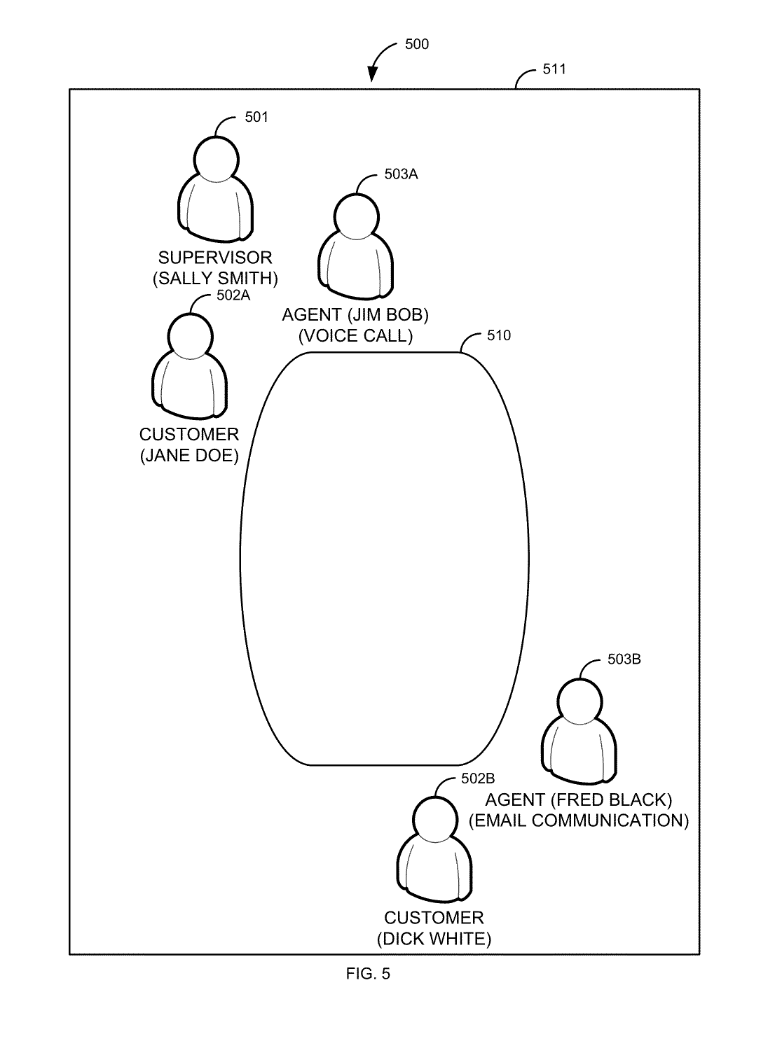

FIG. 5 is an illustrative diagram of a virtual group 500 for multiple communications. The virtual group 500 comprises a monitoring avatar 501, entity avatars 502A and 502B, agent avatars 503A and 503B, a virtual table 510, and a virtual reality setting 511. The virtual group 500 is an exemplary virtual group that can be created based on various criteria. The virtual group 500 shows supervisor Sally Smith (represented by the monitoring avatar 501) monitoring a voice communication between the customer Jane Doe (represented by the entity avatar 502A) and the agent Jim Bob (represented by the agent avatar 503A). In addition, an email communication is taking place between customer Dick White (represented by the entity avatar 502B) and agent Fred Black (represented by the agent avatar 503B). The agent avatars 503A and 503B and the entity avatars 502A and 502B are shown as positioned around the virtual table 510. The monitoring avatar 501 is shown behind the agent avatar 503A and the entity avatar 502A.

Sally Smith from supervisor/SME terminal 140 is currently shown monitoring the voice communication between agent Jim Bob and customer Jane Doe. Sally Smith, from supervisor/SME terminal 140 can move the monitoring avatar 501 into a position behind agent avatar 503B and entity avatar 502B to monitor the email communication taking place between Fred Black and Dick White. In this instance, a window (not shown) would be displayed showing the email communication (or email chain if there is one). Likewise, a text communication between a customer and the agent would be seen if this were a web chat session, a post in progress of an agent responding to a post on FaceBook™, Twitter™, LinkedIn™, Foursquare™, and the like. In addition, a video window can be show if the session were a video session.

FIG. 6 is an illustrative diagram 600 of a virtual group for multiple communications. FIG. 6 illustrates two subject matter experts monitoring a virtual group. The virtual group 600 comprises monitoring avatars 601A and 601B, entity avatars 602A and 602B, agent avatars 603A and 603B, virtual table 610, virtual reality setting 611, and video communication window 620. The virtual group 600 is an exemplary virtual group that can be created based on various criteria. The virtual group 600 shows subject matter expert Sally Smith (represented by the monitoring avatar 601A) monitoring a video communication between customer Jane Doe (represented by the entity avatar 602A) and agent Jim Bob (represented by agent avatar 603A). In addition, an Instant Messaging communication is taking place between customer Dick White (represented by the entity avatar 602B) and agent Fred Black (represented by the agent avatar 603B). The Instant Messaging communication between Fred Black and Dick White is being monitored by subject matter expert Jack Smith. The agent avatars 603A and 603B and the entity avatars 602A and 602B are shown as positioned around the virtual table 610. The monitoring avatar 601A is shown behind the agent avatar 603A and the entity avatar 602A. The monitoring avatar 601B is shown behind the agent avatar 603B and the entity avatar 602B.

Virtual group 600 is shown from the view point of Sally Smith. Sally Smith, from the supervisor/SME terminal 140 is currently shown monitoring the video communication between Jim Bob and Jane Doe. Sally Smith monitors the video communication via video communication window 620. Sally Smith, from the supervisor/SME terminal 140 can move the monitoring avatar 601A into a position behind the agent avatar 603B and the entity avatar 602B to monitor the email communication taking place between Fred Black and Dick White. In this instance, a window (not shown) would be displayed showing the email communication (or email chain if there is one). If the above scenario takes place, both Sally Smith and Jack Smith are monitoring the instant messaging communication between Fred Black and Dick White. In addition, if Jack Smith wants to monitor the video communication between Jim Bob and Jane Doe, Jack Smith could move monitoring avatar 601B behind agent avatar 603A and entity avatar 602A.

Alternatively, Sally Smith or Jack Smith can elect to join any of the monitored communications. For example, Sally Smith can elect to join or barge in to the communication between Jim Bob and Jane Doe by positing monitoring avatar 601A to sit on the left hand side (the open position) next to agent avatar 603A. This can also be accomplished based on a pull down menu, a mouse click, moving the monitoring avatar 601A between the entity avatar 602A and the agent avatar 603A, and the like.

FIG. 7 is an illustrative diagram 700 of combining multiple virtual groups 720A and 720B. The virtual group 720A comprises a monitoring avatar 701, an entity avatar 702A, an agent avatar 703A, a virtual table 710A, a virtual reality setting 711A and a virtual door 721A. The virtual group 720B comprises an entity avatar 702B, an agent avatar 703B, a virtual table 710B, a virtual reality setting 711B and a virtual door 721B.

The virtual groups 720A and 720B are exemplary virtual groups that can be created based on various criteria. The virtual group 720A shows supervisor Sally Smith (represented by the monitoring avatar 701) monitoring a communication between customer Jane Doe (represented by the entity avatar 702A) and agent Jim Bob (represented by the agent avatar 703A). The agent avatar 703A and the entity avatar 702A are shown positioned around the virtual table 710A. The monitoring avatar 701 is shown behind the agent avatar 703A and the entity avatar 702A. The customer Jane Doe is currently in a communication with agent Jim Bob in the virtual group 720A. The virtual group 720A is created based on criteria, such a support for product X.

The virtual group 720B shows the agent avatar 703B and the entity avatar 702B positioned around the virtual table 710A. Agent Jim Bob is in a communication with customer Dick White in the virtual group 720B. The virtual group 720B is created based on criteria such as support for product Y.

Supervisor Sally Smith can move the agent avatar 701 between the virtual groups 720A and 720B to monitor the communication for product X in virtual group 720A and the communication for product Y in virtual group 720B. Supervisor Sally Smith may have to open the virtual door 721A to enter virtual group 720A. The virtual door 721A may have a sign on it identifies the virtual group 720B. Likewise, virtual door 720B may have a sign that identifier the virtual group 720A.

Alternatively, instead of Agent Jim Bob being shown as communicating with different customers, Jim Bob may be shown as in communication with the same customer, but on different mediums. For example, Jim Bob may handling an email and with Jane Doe and also be talking to Jane Doe on a voice communication. Instead of this being in two virtual reality settings 711, it may only be in a single virtual reality setting.

FIG. 8 is an illustrative diagram of a virtual group 800 with multiple communications with a single agent. The virtual group 800 comprises a monitoring avatar 801, entity avatars 802A and 802B, an agent avatar 803, a virtual table 810, a virtual reality setting 811, and a communication window 820. The virtual group 800 is an exemplary virtual group that can be created based on various criteria. The agent avatar 803 and the entity avatars 802A and 802B are shown as positioned around the virtual table 510. The monitoring avatar 801 is shown behind the agent avatar 803 and the entity avatar 802A. In addition, additional customer avatars 802 (not shown) can be shown for customers who are waiting to be serviced. For example, the additional customer avatars 802 may be shown as loitering around virtual reality setting 801. Likewise, if there are agents that are not engaged in a communication, the agents may also be shown as loitering in virtual reality setting 801.

In this illustrative example, agent Jim Bob is engaged in two text communications: 1) with customer Jane Doe and 2) with customer Will Brown. The virtual group 800 shows supervisor Sally Smith (represented by the monitoring avatar 801) monitoring a communication between customer Jane Doe (represented by the entity avatar 802A) and agent Jim Bob (represented by the agent avatar 803). A communication also exists between agent Jim Bob and customer Will Brown (represented by the entity avatar 802B). Other communications that agent Jim Bob is currently involved with can also be shown. For example, an additional entity icon (not shown) could be positioned around virtual table 810.

SME Sally Smith can move monitoring avatar 801 behind each of the entity avatars 802A and 802B to monitor the respective communication with agent Jim Bob. As illustrated, the monitoring avatar 801 is positioned behind entity avatar 802A and the communication between customer Jane Doe and agent Jim Bob is shown in communication window 820. In a similar manner, SME Sally Smith can move monitoring avatar 801 in position behind entity avatar 802B to monitor the communication between agent Jim Bob and customer Will Brown.

Of course, various changes and modifications to the illustrative embodiment described above will be apparent to those skilled in the art. These changes and modifications can be made without departing from the spirit and the scope of the system and method and without diminishing its attendant advantages. The following claims specify the scope of the invention. Those skilled in the art will appreciate that the features described above can be combined in various ways to form multiple variations of the invention. As a result, the invention is not limited to the specific embodiments described above, but only by the following claims and their equivalents.

What is claimed is:

1. A method comprising:
dynamically creating or rendering a first virtual group for monitoring a first communication between a first agent and a first entity, wherein the first virtual group is dynamically created based on a first event that is based on a first criteria and wherein the first virtual group comprises:
a first agent avatar representing the first agent;
a first monitoring avatar representing a person; and
a first virtual reality setting;
displaying the first virtual group to the person; and
presenting the first communication to the person.

2. The method of claim 1, wherein the first virtual group further comprises a first entity avatar that represents the first entity and further comprising:
dynamically modifying the first virtual group based on a second communication that meets the first criteria, wherein the second communication is between a second agent and a second entity, and wherein dynamically modifying the first virtual group comprises:
creating a second agent avatar in the first virtual reality setting; and
creating a second entity avatar in the first virtual reality setting.

3. The method of claim 2, wherein the second communication can be presented to the person based on a movement or position of the monitoring avatar.

4. The method of claim 1, wherein the first virtual group further comprises an first entity avatar that represents the first entity, wherein the person is a supervisor or subject matter expert, and further comprising:
dynamically creating a second virtual group, wherein the second virtual group comprises a second agent avatar and a second entity avatar in a second entity setting, wherein a second entity represented by the second entity avatar and a second agent represented by the second agent avatar are in a second communication, wherein the first virtual reality setting is a first virtual room and the second virtual reality setting is a second virtual room and the first virtual room and the second virtual room are connected, and wherein the first monitoring avatar can virtually go between the first virtual room and the second virtual room.

5. The method of claim 1, wherein the person is a supervisor or subject matter expert and wherein the first event is identified by the supervisor or subject matter expert and wherein a first entity avatar that represents the first entity is also in the first virtual reality setting.

6. The method of claim 5, wherein the person is the supervisor and wherein, based on the first event, the first virtual group represents a plurality of communications between a plurality of agents and a plurality of entities and each of the respective plurality of agents and plurality of entities has a respective avatar.

7. The method of claim 5, wherein the first communication comprises a plurality of communications between the first agent and a plurality of entities that includes the first entity, wherein the first virtual group includes a plurality of entity avatars that represent each of the plurality of entities, and wherein the supervisor can monitor each of the plurality of communications.

8. The method of claim 5, wherein the first entity avatar is visually represented based on a medium of the first communication, wherein the first agent avatar and the first monitoring avatar are visually represented using an avatar of a person and wherein the first agent avatar and the first monitoring avatar are distinguished by at least one of the following: a color, a size, a position, a location, and the first monitoring avatar being shown behind the first agent avatar.

9. The method of claim 1, wherein the first virtual group further comprises a first entity avatar that represents the first entity and further comprising:
dynamically modifying the first virtual group based on a change to the communication, wherein the change to the communication is at least one of the following: an end to the communication, a transfer of the communication, placing the communication on hold, and conferencing the communication.

10. The method of claim 1, wherein the first event is based on at least one of following: a type of customer, a company, a monetary value of the customer, a call type, a key word spoken in the first communication, a key word written in the first communication, an emotion detected in the first communication, a medium type of the first communication, a detected gesture in the first communication, a facial recognition of a person in the first communication, a voice print, a facial expression detected in the first communication, a language spoken in the first communication, a language written in the first communication, a contact history of a person, a skill level of the first agent, a contact center queue, a subject of the first communication, a location of the first agent, a an indication by a supervisor or subject matter expert, and a grouping of agents.

11. The method of claim 1, wherein, based a defined attribute, the monitoring avatar is presented in a view that is shown to a supervisor and the monitoring avatar is not displayed in a view that is presented to the agent.

12. The method of claim 1, wherein the event is based on a product or skill set of a group of agents, wherein for each communication, a corresponding entity avatar is created, and wherein if an agent is not currently involved in a communication, the agent avatar is still created in the virtual group without a corresponding entity avatar and wherein the agent avatar without a corresponding entity avatar can monitor each of the communications.

13. A system comprising:
a virtual group creation module configured to dynamically create or render a first virtual group, wherein the first virtual group is dynamically created based a first event that is based on a first criteria and the first virtual group comprises:
a first agent avatar representing a first agent;
a first monitoring avatar, representing a person; and
a first virtual reality setting;
a rendering module configured to render the first virtual group for display and present the first communication to the person; and
a communication monitoring module configured to monitor the first communication between the first agent and the first entity.

14. The system of claim 13, wherein the first virtual group further comprises a first entity avatar that represents the first entity and wherein the virtual group creation module is further configured to:
dynamically modify the first virtual group based on a second communication that meets the first criteria, wherein the second communication is between a second agent and a second entity, and wherein dynamically modifying the first virtual group comprises:
creating a second agent avatar in the first virtual reality setting; and
creating a second entity avatar in the first virtual reality setting.

15. The system of claim 14, wherein the second communication can be presented to the person based on a movement or position of the monitoring avatar.

16. The system of claim 13, wherein the first virtual group further comprises an first entity avatar that represents the first entity, wherein the person is a supervisor or subject matter expert, and wherein the virtual group creation module is further configured to:
dynamically create a second virtual group, wherein the second virtual group comprises a second agent avatar and a second entity avatar in a second virtual reality setting, wherein a second entity represented by the second entity avatar and a second agent represented by the second agent avatar are in a second communication, wherein the first virtual reality setting is a first virtual room and the second virtual reality setting is a second virtual room and the first virtual room and the second virtual room are connected, and wherein the first monitoring avatar can virtually go between the first virtual room and the second virtual room.

17. The system of claim 13, wherein the person is a supervisor or subject matter expert and wherein the first event is identified by the supervisor or subject matter expert and wherein a first entity avatar that represents the first entity is also in the first virtual reality setting.

18. The system of claim 17, wherein the person is the supervisor and wherein, based on the first event, the first virtual group represents a plurality of communications between a plurality of agents and a plurality of entities and each of the respective plurality of agents and plurality of entities has a respective avatar.

19. The system of claim 17, wherein the first communication comprises a plurality of communications between the first agent and a plurality of entities that includes the first entity, wherein the first virtual group includes a plurality of entity avatars that represent each of the plurality of entities, and wherein the supervisor can monitor each of the plurality of communications.

20. A non-transient computer readable medium having stored thereon instructions that cause a processor to execute a method, the method comprising:
instructions to dynamically create or render a first virtual group for monitoring a first communication between a first agent and a first entity, wherein the first virtual group is dynamically created based a first event that is based on a first criteria and the first virtual group comprises:
instructions to create a first agent avatar representing the first agent;
instructions to create a first monitoring avatar representing a person; and
instructions to create a first virtual reality setting;
instructions to display the first virtual group; and
instructions to present the first communication to the person.
